(19) United States
(12) Patent Application Publication
(10) Pub. No.: US 2022/0146686 A1
(43) Pub. Date: May 12, 2022

(54) LASER EMISSION APPARATUS AND LIDAR-BASED SURROUND SENSOR HAVING A LASER EMISSION APPARATUS

(71) Applicant: Valeo Schalter und Sensoren GmbH, Bietigheim-Bissingen (DE)

(72) Inventors: Lin Lin, Bietigheim-Bissingen (DE); Ho-Hoai-Duc Nguyen, Bietigheim-Bissingen (DE); Daniel Stricker-Shaver, Bietigheim-Bissingen (DE); Thomas Schuler, Bietigheim-Bissingen (DE)

(73) Assignee: Valeo Schalter und Sensoren GmbH, Bietigheim-Bissingen (DE)

(21) Appl. No.: 17/598,548

(22) PCT Filed: Mar. 17, 2020
(86) PCT No.: PCT/EP2020/057230

§ 371 Date: Sep. 27, 2021

(30) Foreign Application Priority Data
Mar. 28, 2019 (DE) 10 2019 107 998.5

(51) Int. Cl. G01S 17/931; G01S 7/481; G01S 7/4865

(52) U.S. Cl. CPC G01S 17/931; G01S 7/4865; G01S 7/4817; G01S 7/4814

(57) ABSTRACT

A laser emission apparatus for a LiDAR-based surround sensor for use in a vehicle includes a laser light source for generating pulsed laser beams, a laser beam splitting unit that produces, from the pulsed laser beams, pulsed individual beams that are arranged in a horizontal plane and are aligned distributed with a uniform angular distance in a specified angular range, and a movable diversion mirror pivotable both about a horizontal axis and also about a vertical axis to divert the pulsed individual beams into a two-dimensional emission region. The diversion mirror is pivotable about the vertical axis within an angular range to cause the angular distance between adjacent pulsed individual beams to be covered by the diversion of the pulsed individual beams. Also disclosed is a LiDAR-based surround sensor for use in a vehicle with a laser emission apparatus and a reception unit.

The present invention relates to a laser emission apparatus, in particular for a LiDAR-based surround sensor for use in a vehicle.

The present invention also relates to a LiDAR-based surround sensor, in particular for use in a vehicle, having an aforementioned laser emission apparatus and a reception unit for receiving reflections of the pulsed individual beams emitted by the laser emission apparatus in the emission region.

In LiDAR-based surround sensors, objects in a surrounding area are captured according to the “time-of-flight” principle. This involves individual laser pulses being emitted by a laser emission apparatus and reflections of these laser pulses at the objects in the surrounding area being received using the reception unit and being evaluated. From a time difference between the emission of a laser pulse and the reception of its reflection at objects in the surrounding area, the distance from the respective object can be captured. In addition, it is also possible to ascertain an intensity of the received reflection in order to acquire in this way additional information relating to a nature of the object.

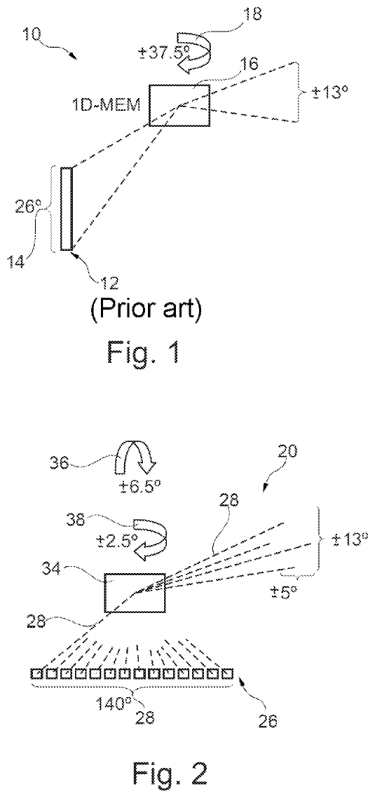

A laser emission apparatus 10 of such a LiDAR-based surround sensor is illustrated in FIG. 1. The laser emission apparatus 10 comprises a laser light source (not illustrated here) for generating pulsed laser beams. The pulsed laser beams are expanded in a vertical direction in a laser beam splitting unit 12, which is shown here schematically, such that they form a vertical bar 14. This bar 14 is directed via different optical elements, such as lenses and mirrors (which are not illustrated here) onto a movable diversion mirror 16. The movable diversion mirror 16 is designed to be pivotable about a vertical axis 18. Through the combination of the vertical bar 14 and the movement of the diversion mirror 16 about the vertical axis 18, a two-dimensional emission region is covered. The bar 14 here has an opening angle of 26°, while the diversion mirror 16 is pivotable in an angular range of +/−37.5°. It is thereby possible to cover the two-dimensional emission region with a horizontal angular range of 150° and a vertical angular range of 26°. The bar 14 spans a solid angle of approximately 26°×0.1°. In other words, the horizontal resolution is given by the 0.1°. In this case, 1500 angles therefore need to be scanned. Consequently, the horizontal resolution is specified by the laser bar thinness, and the vertical resolution is specified by the reception unit or number of vertical reception elements.

The LiDAR-based surround sensor furthermore comprises a reception unit (not illustrated here) for receiving reflections of the laser pulses emitted by the laser emission apparatus 10 in the emission region. The reception unit has a plurality of reception elements for receiving light having the wavelength of the pulsed laser beams, which are arranged in the manner of a matrix in a two-dimensional field. In addition, the reception unit can have optical elements to guide the reflections in a suitable manner onto the reception units.

It is possible here to selectively activate individual, vertical rows of the reception units in accordance with an angular position of the bar 14 for receiving the reflections of the emitted laser pulses. In the vertical direction, the reflections are guided in a suitable manner onto the reception units, with the result that the reflections can be assigned to a vertical angular position. Current LiDAR-based surround sensors here achieve, in the vertical direction, a resolution of, for example, 3.2° with 4 reception units of 0.8° each, 10° with 16 reception units of 0.625° each or, for example, 26° with 130 reception units of 0.2° each. For example, the bar 14 in each of the aforementioned configurations has a width of 0.1°.

These LiDAR-based surround sensors come with different challenges. One challenge consists in capturing the surrounding area at as high a frequency as possible. The frequency of the capturing in the current LiDAR-based surround sensors is limited, firstly, by a maximum pulse frequency of the laser light source used, and, in addition, by a desired or required angle resolution together with a captured angular range of the surrounding area. Current laser light sources enable a generation of, for example, approx. 30,000 to 40,000 pulses per second. When capturing a horizontal angular range of 145° with a resolution of 0.25°, for example 581 laser pulses are necessary to capture the entire horizontal angular range. So, a pulse frequency of 30 kHz gives a frame rate of less than 52 Hz.

Another challenge consists in the capturing of an angular range of the surrounding area that is large as possible using a LiDAR-based surround sensor. The angular range in the case of the current LiDAR-based surround sensors is limited, for example, by the diversion mirror. Current diversion mirrors in MEMS technology allow, for example, a deflection by +/−10°. However, in order to cover an angular range of the surrounding area of, for example, 150°, diversion mirrors having a deflection of +/−37.5° are necessary, so that, in the case of the respective maximum deflection of the diversion mirror, the pulsed laser beam can be emitted at an angle of +/−75°. This results in what is known as a field of view (FoV) of 150° for the LiDAR-based surround sensor.

In current LiDAR-based surround sensors, what is known as the “smiley” effect also frequently occurs, i.e. the reflections in the surrounding area are captured with a distortion. As a result, capturing in the horizontal direction may not take place with horizontal lines, but the lines are distorted in the manner of a circular arc segment. This makes the evaluation of the received reflections and the assignment of the received reflections of the captured objects to positions in the surrounding area of the vehicle more difficult.

In this respect, a laser scanning apparatus is known from EP 2 829 894 A1. The laser scanning apparatus comprises a light source and a light scanner, which scans laser light emitted by the laser light source. The light source is configured to emit laser light from a plurality of directions onto the light scanner.

Furthermore, US 2012/0236379 A1 discloses that a scanning mirror contains a substrate that is structured to contain a mirror region, a frame around the mirror region, and a base around the frame. A set of actuators rotates the mirror region about a first axis relative to the frame, and a second set of actuators rotates the frame about a second axis relative to the base. The scanning mirror can be produced using semiconductor processing techniques or processing techniques that do not require a clean-room process. A drive system for the scanning mirror can use feedback loops that operate the mirror for triangular movements. Other embodiments of the scanning mirror can be used in a LADAR system for a natural user interface of a computer system.

US 2015/0109604 A1 relates to a distance measurement apparatus using laser light. The distance measurement apparatus comprises: a laser light source; a first optical element, which converts laser light emitted by the laser light source into collimated light; a light-diverting apparatus, which comprises an oscillating mirror and which scans the laser light on a surface of an object to be measured; a varifocal lens, which is arranged between the first optical element and the light-diverting apparatus and which converges the scanning laser light, which has been scanned by the light-diverting apparatus, on the surface of a measurement part; and a light amount detector, which captures a maximum value of a light amount of reflected light that is reflected by the surface of the measurement part.

Starting from the abovementioned prior art, the invention is thus based on the object of specifying a laser emission apparatus and a LiDAR-based surround sensor of the abovementioned type, which overcome at least some of the aforementioned challenges and enable reliable and cost-effective capturing of objects in a surrounding area.

The object is achieved according to the invention by the features of the independent claims. Advantageous refinements of the invention are specified in the dependent claims.

According to the invention, a laser emission apparatus, in particular for a LiDAR-based surround sensor for use in a vehicle, is specified, comprising a laser light source for generating pulsed laser beams, a laser beam splitting unit that produces, from the pulsed laser beams, a plurality of pulsed individual beams that are arranged in a horizontal plane and are aligned distributed with a uniform angular distance in a specified angular range, and a movable diversion mirror, which is designed to be pivotable both about a horizontal axis and also about a vertical axis to divert the pulsed individual beams into a two-dimensional emission region, wherein the diversion mirror is pivotable about the vertical axis within an angular range to cause the angular distance between adjacent pulsed individual beams to be covered by the diversion of the pulsed individual beams.

The invention also specifies a LiDAR-based surround sensor, in particular for use in a vehicle, having an aforementioned laser emission apparatus and a reception unit for receiving reflections of the pulsed individual beams emitted by the laser emission apparatus in the emission region.

It is thus a fundamental concept of the present invention to cover the emission region, based on the pulsed individual beams, by the arrangement in the specified angular range and the distributed alignment of the pulsed individual beams with a uniform angular distance. In contrast to the prior art, the pulsed individual beams in the horizontal plane are aligned such that, between positions of the pulsed individual beams, free spaces are formed, which can be covered with a plurality of pulsed laser beams due to the pivot movement of the diversion mirror about the vertical axis. In comparison with the prior art, in which the pivoting of the diversion mirror defines a horizontal extent of the diversion region, the result here is that, overall, only very small deflections of the diversion mirror are necessary to completely encompass the horizontal extent of the diversion region with the pulsed individual beams. This results in various advantages, as will be described below.

Due to the small deflections of the diversion mirror, what is known as the “smiley” effect, according to which the surrounding area is captured with a distortion, can be significantly reduced. As a result, the capturing of the reflections in the horizontal plane and the assignment of the received reflections of the captured objects to positions in the surrounding area can be made significantly easier.

In addition, a large emission region of the laser emission apparatus in the horizontal direction can be implemented with simple and thus cost-effective diversion mirrors, which have to support only a small pivot region about the horizontal and vertical axes. Limitations of the emission region of the laser emission apparatus due to a small maximum pivot region of the diversion mirror in the horizontal direction, that is to say pivoting about the vertical axis, can thus be overcome.

The required deflection in the horizontal direction is obtained from an angular distance of the pulsed individual beams relative to one another, which is dependent on the number of the pulsed individual beams. The angular distance of the pulsed individual beams relative to one another can be very small with respect to the extent of the emission region of the laser emission apparatus in the horizontal direction. By using the laser emission apparatus or the LiDAR-based surround sensor in the vehicle, typically only a small extent of the emission region of the laser emission apparatus in the vertical direction is required, which means that even in this direction likewise only a small maximum pivot region of the diversion mirror is required.

The use of the pulsed individual beams as such is also already advantageous with respect to the bar-shaped expansion of the pulsed laser beam because the received reflections can be easily assigned to a position. Crosstalk, that is to say a superposition of the reflections between different reception elements, can be largely avoided. As a result, the number of the reception elements of the reception unit can also be low.

Depending on a number of the pulsed individual beams, a high frequency of the capturing of the surrounding area can additionally be achieved. The frequency of the capturing in the case of the LiDAR-based surround sensors is based on a maximum pulse frequency of the laser light source used, a desired or required angle resolution of the pulsed individual beams in the emission region, and an extent of the emission region of the laser emission apparatus. The frequency of the capturing can thus be increased by way of a greater number of the pulsed individual beams with otherwise identical parameters.

The laser emission apparatus is used in the LiDAR-based surround sensor to cover the two-dimensional emission region with the pulsed individual beams. Reflections of the pulsed individual beams at objects in the surrounding area are received by the reception unit. Based on this, distances from the objects can be determined, according to the time-of-flight (ToF) principle, based on a time of flight from the emission of a pulsed laser beam to the reception of the respective reflections.

The LiDAR-based surround sensor is designed for use in a vehicle. Consequently, the LiDAR-based surround sensor overall is designed to be as compact as possible. The LiDAR-based surround sensor typically provides sensor information with the distances from the objects in the surrounding area and their positions in the emission region to a driver assistance system of the vehicle. The vehicle can fundamentally be any desired vehicle. The vehicle is preferably designed for partially autonomous or autonomous driving.

The laser light source generates the pulsed laser beams. The laser light source is preferably designed to generate pulsed laser beams that are not dangerous for human beings, i.e. what is known as a Class 1 laser.

The laser beam splitting unit produces in each case a plurality of pulsed individual beams from the pulsed laser beams. The number of the pulsed individual beams can in this case fundamentally be selected as desired, wherein the energy of the pulsed individual beams in sum cannot be greater than the energy of the pulsed laser beam.

The horizontal plane is typically a plane parallel to a ground plane in the region of the vehicle. The horizontal plane is aligned with reference to the vehicle, so that, if the vehicle is inclined, deviations from an absolute horizontal alignment can occur.

The distributed arrangement of the pulsed individual beams in the specified angular range with the uniform angular distance ensures that the emission region can be covered completely and efficiently with the pulsed individual beams. Gaps between the pulsed individual beams in the emission region can be avoided.

The movable diversion mirror is preferably designed as a MEMS mirror, that is to say in micro system technology. The diversion mirror is pivotable about the two orthogonal axes to divert the pulsed individual beams into the two-dimensional emission region.

The diversion mirror is pivotable in the vertical direction in a vertical angular range in order to ensure coverage of a vertical angular range by way of the diversion of the pulsed individual beams. In typical applications in the automotive sector, capturing objects in a region above a ground surface is particularly important. Accordingly, the diversion mirror can be designed with a merely small maximum deflection in the vertical direction. A vertical extent of the emission region is typically no more than 45°, preferably no more than 30°. The maximum deflection of the diversion mirror in the vertical direction can thus be, for example, 15°, or, in a deviating definition, +/−7.5°.

The emission region relates to a region of the emission of the pulsed individual beams using the laser emission apparatus into the surrounding area. Accordingly, reflections of the pulsed individual beams in the emission region can also be received by the reception unit. In this way, the emission region at the same time defines a maximum reception region of the LiDAR-based surround sensor. Typically, the reception region is identical to the emission region. The reception region is also referred to as field of view (FoV).

In an advantageous refinement of the invention, the laser beam splitting unit has a diffraction element, which produces the plurality of pulsed individual beams from the pulsed laser beam. The splitting of the pulsed laser beam is thus based on the principle of optical diffraction. Corresponding diffraction elements have small dimensions and can be produced cost-effectively and compactly. The use of the diffraction element additionally allows efficient utilization of the pulsed laser beams generated by the laser light source, since only small losses occur. Losses as they occur, for example, due to pinhole masks, can be avoided.

In an advantageous refinement of the invention, the diffraction element is designed as a translucent carrier element with a line pattern. The diffraction element can thus be designed in the manner of a slide. Such a diffraction element can have very small dimensions and therefore allows a particularly compact configuration both of the laser emission apparatus and also of the LiDAR-based surround sensor. The line pattern here defines the diffraction of the pulsed laser beam and consequently the splitting of the pulsed laser beam into the pulsed individual beams.

In an advantageous refinement of the invention, the laser beam splitting unit has a refraction element, which refracts the plurality of pulsed individual beams together, in particular for fanning out the plurality of pulsed individual beams within the plane. Starting from the already completed splitting of the pulsed laser beam into the pulsed individual beams, the pulsed individual beams can be aligned such that they can completely cover the desired angular range. The pulsed individual beams can thus, for example, initially be split and then be aligned distributed in the specified angular range. The alignment of the pulsed individual beams in the specified angular range can also take place, for example, in multiple stages.

In an advantageous refinement of the invention, the laser beam splitting unit is arranged in the optical path of the emitted pulsed laser beams between the laser light source and the diversion mirror. Consequently, the laser beam splitting unit can have a compact design because the pulsed laser beams are always incident on the laser beam splitting unit at a specified position. It is preferred in this case that the laser beam splitting unit is positioned spatially close to the diversion mirror so that the pulsed individual beams are reliably incident on the diversion mirror without the latter having to have an increased horizontal extent. A small diversion mirror has a low mass and can be pivoted easily and quickly.

Alternatively, the laser beam splitting unit is arranged in the optical path of the emitted pulsed laser beams downstream of the diversion mirror. As a result, the pulsed laser beams are always incident on the diversion mirror at a specified position, which means that the diversion mirror can have a compact design. This is advantageous because a compact, small diversion mirror has a low mass and can be pivoted easily and quickly. It is preferred in this case that the laser beam splitting unit is positioned spatially close to the diversion mirror so that the pulsed individual beams are reliably incident on the laser beam splitting unit without the latter having to have an increased horizontal and/or vertical extent. The laser beam splitting unit should be configured accordingly such that the pulsed laser beam, after being diverted by the diversion mirror, is reliably and uniformly split into the plurality of pulsed individual beams.

In an advantageous refinement of the invention, the laser beam splitting unit is embodied to produce, from the pulsed laser beams, at least ten pulsed individual beams, preferably at least fifteen pulsed individual beams. A number of the pulsed individual beams is not limited in principle. However, the specified energy of the pulsed laser beam emitted by the laser light source means that the energy of the laser light source can be split merely over a limited number of pulsed individual beams in order to be able to still capture the reflections of the pulsed individual beams. Splitting the pulsed laser beam into as large a number of pulsed individual beams as possible is advantageous because in this way scanning times for completely capturing the reflections in the emission region can be reduced. This requires a compromise between a size of the emission region and an angle resolution both in the horizontal and also in the vertical direction in order to achieve a desired scanning time with a given pulse frequency of the laser light source. Splitting into at least ten pulsed individual beams and preferably at least fifteen pulsed individual beams has proven particularly suitable here to allow reliable capturing of the reflections of objects at a sufficient distance.

In an advantageous refinement of the invention, the laser beam splitting unit is designed to align the pulsed individual beams in a specified angular range of at least approximately 70°, preferably at least approximately 100°, with particular preference approximately 140°. The angular range of the pulsed individual beams defines, together with the maximum deflection of the diversion mirror in the horizontal direction, that is to say a pivot movement of the diversion mirror about the vertical axis, a maximum horizontal angular extent of the emission region of the laser emission apparatus. A similar result is obtained for the reception region of the LiDAR-based surround sensor.

In an advantageous refinement of the invention, the laser emission apparatus, preferably the laser beam splitting unit, has at least one optical element for beam shaping the pulsed laser beam and/or the pulsed individual beams. The beam shaping can be performed in this case either for the pulsed laser beams or for the pulsed individual beams into which the pulsed laser beams are split. In principle, in the case of a plurality of optical elements, the beam shaping can be performed both for the pulsed laser beams and also for the pulsed individual beams. For example, a divergence of the pulsed laser beam is transferred, due to the splitting, to each of the pulsed individual beams such that the beam shaping of the pulsed laser beams also brings about beam shaping of the pulsed individual beams. The beam shaping allows the provision of the pulsed individual beams with a low divergence and/or a high coherence. In principle, the at least one optical element can also be arranged in the optical path of the pulsed laser beam at a different location, for example in the laser light source or as a separate optical element.

In an advantageous refinement of the invention, the reception unit has, for receiving the reflections of the pulsed individual beams emitted by the laser emission apparatus in the emission region, a plurality of reception elements arranged in a two-dimensional field according to an angle resolution of the laser emission apparatus. The reception elements are light-sensitive elements that receive in particular light of the wavelength of the laser emission apparatus and convert it into electrical signals. The arrangement of the reception elements is realized in the two-dimensional field, wherein the reception elements are preferably uniformly spaced apart. The laser emission apparatus in this case is designed with a uniform angle resolution in the corresponding direction over the emission region. The distances can here differ in each of the two directions. Due to the pulsed individual beams having an approximately point-shaped extent, the reflections of said pulsed individual beams can be reliably received by the reception elements. Special measures for identifying and assigning the reflections to the pulsed individual beams are not necessary.

In an advantageous refinement of the invention, the LiDAR-based surround sensor has an optical device, which is connected upstream of the reception unit and guides the reflections of the pulsed individual beams emitted by the laser emission apparatus in the emission region onto the reception elements that correspond in terms of the horizontal and vertical angle position thereof. This improves the reception of the reflections of the emitted pulsed individual beams and can increase their intensity at the reception elements.

The invention is explained in more detail below with reference to the attached drawing and on the basis of preferred embodiments. The features described can represent an aspect of the invention both individually and in combination. Features of different exemplary embodiments can be transferred from one exemplary embodiment to another.

In the drawings:

FIG. 1 shows a schematic, partial view of a laser emission apparatus, in particular for a LiDAR-based surround sensor for use in a vehicle, from the prior art, having a laser beam splitting unit and a diversion mirror that is pivotable about a vertical axis,

FIG. 2 shows a schematic, partial view of a laser emission apparatus, in particular for a LiDAR-based surround sensor for use in a vehicle, according to a first, preferred embodiment, having a laser beam splitting unit and a diversion mirror that is pivotable about a horizontal axis and also about a vertical axis, and

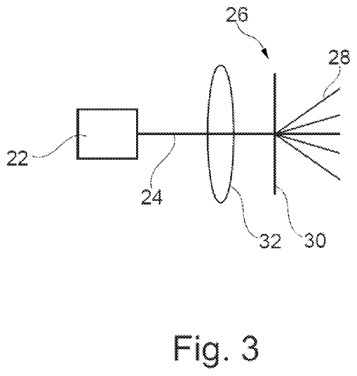

FIG. 3 shows a schematic, partial view of the laser emission apparatus from FIG. 2, having a laser light source and the laser beam splitting unit already illustrated in FIG. 2.

FIGS. 2 and 3 show a laser emission apparatus 20 according to a first, preferred embodiment of the invention. The laser emission apparatus 20 is part of a LiDAR-based surround sensor (not illustrated in more detail) for use in a vehicle (likewise not illustrated in more detail). Details relating to the LiDAR-based surround sensor are mentioned below.

The laser emission apparatus 20 comprises a laser light source 22 for generating pulsed laser beams 24. The laser light source 22 is designed to generate pulsed laser beams 24 that are not dangerous for human beings, i.e. what is known as a Class 1 laser. Laser light sources 22 as such are known in the prior art, and a detailed description is therefore omitted here.

The laser emission apparatus 20 furthermore comprises a laser beam splitting unit 26, which produces, from the pulsed laser beams 24, a plurality of pulsed individual beams 28 in this exemplary embodiment. The pulsed individual beams 28 are here arranged in a horizontal plane and are aligned distributed in a specified angular range with a uniform angular distance. The horizontal plane in this connection is a plane parallel to a ground plane in the region of the vehicle. The horizontal plane is aligned with reference to the vehicle, so that, if the vehicle is inclined, deviations from an absolute horizontal alignment can occur.

In this exemplary embodiment, the laser beam splitting unit 26 has a diffraction element 30, which produces, from the pulsed laser beams 24, in each case the plurality of pulsed individual beams 28. The use of the diffraction element 30 allows efficient utilization of the pulsed laser beams 24 generated by the laser light source 22, since only small power losses occur. In detail, the diffraction element 30 is here designed as a translucent carrier element with a line pattern for deflecting and correspondingly splitting the pulse laser beam 24. The diffraction element 30 in the present case is designed in the manner of a slide and has very small dimensions. This allows a particularly compact configuration of the laser emission apparatus 20 and also of the LiDAR-based surround sensor.

The line pattern of the diffraction element 30 defines the diffraction of the pulsed laser beam 24 and the splitting thereof into the pulsed individual beams 28 and the distribution of the latter. In this exemplary embodiment, the laser beam splitting unit 26 is configured to produce, from the pulsed laser beams 24, in each case fifteen pulsed individual beams 28. The angular range in which the fifteen pulsed individual beams 28 are aligned is here approximately 140°.

An optical element 32 for beam shaping the pulsed laser beam 24 is arranged in the region between the laser light source 22 and the laser beam splitting unit 26. The beam shaping allows the provision of the pulsed laser beam 24 and consequently also of the individual beams 28 with a low divergence and/or with a high coherence. The optical element 32 is here designed as an optical lens.

In an alternative embodiment, the optical element 32 for beam shaping the pulsed laser beam 24 is designed and arranged as part of the laser beam splitting unit 26. In a further alternative embodiment, the optical element 32 is designed for beam shaping the pulsed individual beams 28 and arranged in an optical path of the emitted pulsed laser beam 24 downstream of the diffraction element 30.

The laser emission apparatus 20 likewise comprises a movable diversion mirror 34, which is configured to be pivotable both about a horizontal axis 36 and also about a vertical axis 38. The movable diversion mirror 34 in this exemplary embodiment is designed as a MEMS mirror, that is to say in micro system technology.

The diversion mirror 34 thus diverts the pulsed individual beams 28 into a two-dimensional emission region. As is illustrated in FIG. 2, the diversion mirror 34 is pivotable about the horizontal axis 36 in an angular range of +/−6.5° and about the vertical axis 38 in an angular range of +/−2.5° Consequently, each of the pulsed individual beams 28 can be diverted vertically about +/−13° and horizontally about +/−5°. The required deflection in the horizontal direction, that is to say the required pivoting about the vertical axis 38, is the result of the angular distance of the pulsed individual beams 28 relative to one another. Splitting the pulsed laser beam 24 into fifteen pulsed individual beams 28 in the angular range of 150° results here in an angular distance of the pulsed individual beams 28 relative to one another of approximately 10°. The result of pivoting the diversion mirror 34 is that the pulsed individual beams 28, which are arranged in the horizontal plane in the angular range of approximately 140°, allow a coverage in the two-dimensional emission region of 150° in the horizontal direction and of 26° in the vertical direction.

Moreover, the pulsed individual beams 28 can be diverted by pivoting the diversion mirror 34 about the horizontal axis 36 in the vertical direction in the angular range of +/−6.5° so as to bring about, in the two-dimensional emission region in the horizontal direction, a coverage in the angular distance between the respectively adjacent pulsed individual beams 28 according to a desired resolution in the horizontal direction. Due to the small deflections of the diversion mirror 34, what is known as the “smiley” effect, according to which the surrounding area is captured with a distortion, can be significantly reduced. As a result, the capturing of the reflections of the pulsed individual beams 28 in the horizontal plane and the assignment of the received reflections of the captured objects to positions in the surrounding area can be made significantly easier.

The emission region relates to a region of the emission of the pulsed individual beams 28 using the laser emission apparatus 20 into the surrounding area. Accordingly, reflections of the pulsed individual beams 28 maximally in the emission region can also be received by the reception unit. In this way, the emission region at the same time defines a maximum reception region of the LiDAR-based surround sensor. In principle, the reception region can also be smaller than the emission region. Typically, the reception region is identical to the emission region. The reception region is also referred to as field of view (FoV).

For the laser emission apparatus 20 overall, this results in an arrangement in which the laser beam splitting unit 26 is arranged in the optical path of the emitted pulsed laser beams 24 between the laser light source 22 and the diversion mirror 34. Consequently, the laser beam splitting unit 26 can have a compact design because the pulsed laser beams 24 are always incident on the laser beam splitting unit 26 at a specified position. It is preferred in this case that the laser beam splitting unit 26 is positioned spatially close to the diversion mirror 34 so that the pulsed individual beams 28 are reliably incident on the diversion mirror 34 without the latter having to have an increased horizontal extent. A small diversion mirror 34 has a low mass and can be pivoted easily and quickly.

The LiDAR-based surround sensor typically provides sensor information with the distances from the objects in the surrounding area and their positions in the emission region to a driver assistance system of the vehicle. The vehicle can fundamentally be any desired vehicle. The vehicle is preferably designed for partially autonomous or autonomous driving. The laser emission apparatus 20 is used in the LiDAR-based surround sensor to cover the two-dimensional emission region with the pulsed individual beams 28.

The LiDAR-based surround sensor (not illustrated in more detail) comprises, in addition to the laser emission apparatus 20, a reception unit for receiving reflections of the pulsed individual beams 28 emitted by the laser emission apparatus 20 in the emission region. Based on this, distances from the objects can be determined, according to the time-of-flight (ToF) principle, based on a time of flight from the emission of a pulsed laser beam 24 to the reception of the respective reflections.

For receiving the reflections of the pulsed individual beams 28 emitted by the laser emission apparatus 20 in the emission region, the reception unit has a plurality of reception elements, which are arranged in a two-dimensional field according to an angle resolution of the laser emission apparatus 20 in the horizontal and vertical direction. The reception elements are light-sensitive elements that receive in particular light of the wavelength of the laser emission apparatus 20 and convert it into electrical signals. The arrangement of the reception elements is realized in the two-dimensional field, wherein the reception elements are uniformly spaced apart. The laser emission apparatus 20 thus has a uniform angle resolution in the horizontal direction over the emission region. Due to the pulsed individual beams 28 having an approximately point-shaped extent, the reflections of said pulsed individual beams 28 can be reliably received by the reception elements. In this case, the LiDAR-based surround sensor can have an optical device, which is connected upstream of the reception unit and guides the reflections of the pulsed individual beams 28 emitted by the laser emission apparatus 20 in the emission region onto the reception elements that correspond in terms of the horizontal and vertical angle position thereof.

Owing to the use of the pulsed individual beams 28, the received reflections can be easily assigned to a position. Crosstalk, that is to say a superposition of the reflections between different reception elements, can be largely avoided, and the reception unit therefore has only a small number of the reception elements. Preferably, at least one unused reception channel lies between two expected signal-including reception channels in order to reduce crosstalk.

### LIST OF REFERENCE SIGNS

10 Laser emission apparatus (prior art)
12 Laser beam splitting unit (prior art)
14 Bar (prior art)
16 Diversion mirror (prior art)
18 Vertical axis (prior art)
20 Laser emission apparatus
22 Laser light source
24 Laser beam
26 Laser beam splitting unit
28 Individual beam
30 Diffraction element
32 Optical element
34 Diversion mirror
36 Horizontal axis
38 Vertical axis

1. A laser emission apparatus for a LiDAR-based surround sensor for use in a vehicle, comprising:
a laser light source for generating pulsed laser beams;
a laser beam splitting unit, which produces, from the pulsed laser beams, a plurality of pulsed individual beams, which are arranged in a horizontal plane and are aligned distributed in a specified angular range with a uniform angular distance; and
a movable diversion mirror pivotable both about a horizontal axis and also about a vertical axis in order to divert the pulsed individual beams into a two-dimensional emission region,
wherein the diversion mirror is pivotable about the vertical axis in an angular range in order to ensure coverage of the angular distance between adjacent pulsed individual beams by way of the diversion of the pulsed individual beams.

2. The laser emission apparatus according to claim 1, wherein the laser beam splitting unit has a diffraction element, which produces, from the pulsed laser beam, the plurality of pulsed individual beams.

3. The laser emission apparatus according to claim 2, wherein the diffraction element is a translucent carrier element with a line pattern.

4. The laser emission apparatus according to claim 1, wherein the laser beam splitting unit has a refraction element, which refracts the plurality of pulsed individual beams together for fanning out the plurality of pulsed individual beams within the plane.

5. The laser emission apparatus according to claim 1, wherein the laser beam splitting unit is arranged in the optical path of the emitted pulsed laser beams between the laser light source and the diversion mirror.

6. The laser emission apparatus according to claim 1, wherein the laser beam splitting unit is embodied to produce, from the pulsed laser beams, at least ten pulsed individual beams.

7. The laser emission apparatus according to claim 1, wherein the laser beam splitting unit is configured to align the pulsed individual beams in a specified angular range of at least approximately 100°.

8. The laser emission apparatus according to claim 1, wherein laser beam splitting unit has at least one optical element for beam shaping the pulsed laser beam and/or the pulsed individual beams.

9. A LiDAR-based surround sensor for use in a vehicle, comprising:
a laser emission apparatus according to claim 1; and
a reception unit for receiving reflections of the pulsed individual beams emitted by the laser emission apparatus in the emission region.

10. The LiDAR-based surround sensor according to claim 9, wherein, for receiving the reflections of the pulsed individual beams emitted by the laser emission apparatus in the emission region, the reception unit has a plurality of reception elements, which are arranged in a two-dimensional field according to an angle resolution of the laser emission apparatus.

11. The LiDAR-based surround sensor according to claim 10, wherein the LiDAR-based surround sensor has an optical device, which is connected upstream of the reception unit and guides the reflections of the pulsed individual beams emitted by the laser emission apparatus in the emission region onto the reception elements that correspond in terms of the horizontal and vertical angle position thereof.
